(19) United States
(12) Patent Application Publication
(10) Pub. No.: US 2012/0271759 A1
(43) Pub. Date: Oct. 25, 2012

(54) Online Membership Incentive System & Method

(76) Inventor: Jong Lee, Calabasas, CA (US)

(21) Appl. No.: 13/503,831

(22) PCT Filed: Mar. 9, 2012
(86) PCT No.: PCT/US12/28384

§ 371 Date: Apr. 24, 2012

Related U.S. Application Data
(60) Provisional application No. 61/464,959, filed on Mar. 11, 2011.
(60) Provisional application No. 61/468,186, filed on Mar. 28, 2011.
(60) Provisional application No. 61/478,734, filed on Apr. 25, 2011.
(60) Provisional application No. 61/510,131, filed on Jul. 21, 2011.

(51) Int. Cl. G06Q 40/00

(52) U.S. Cl. 705/39; 705/35

(57) ABSTRACT

An incentive system for members of an online community to contribute quality content based on members voting for content with a virtual token system. Acquisition of virtual tokens by contributing members of the online community is used by the online community computer system to calculate and distribute shares of online community revenue to contributing members. A method to prevent revenue sharing fraud by community members may also be implemented.

This application claims the benefit of priority of U.S. provisional patent applications 61/464,959 filed on Mar. 11, 2011, 61/468,186 filed on Mar. 28, 2011, 61/478,734 filed on Apr. 25, 2011, and 61/510,131 filed on Jul. 21, 2011, the contents of all of which are hereby incorporated by reference.

### TECHNICAL FIELD

The present invention relates to a system and method for giving an incentive for user participation in an online community by revenue sharing.

### BACKGROUND ART

The internet has facilitated the growth of online communities where users having particular interests or questions about a topic can come together through a website to share information. The vitality of an online community of users is affected by the quality of the community members' experience, which is in many cases affected by the quality of content (e.g. information) available to the community members on the website. Quality content however frequently takes an investment of time and energy for community members to create and share with other members. Accordingly, it is desirable to provide an incentive to members of an online community to participate and contribute quality content.

### DISCLOSURE OF THE INVENTION

An object of this invention is to provide a method and system whereby members of an online community, such as a website, operated by a computer system will have an incentive and be motivated to provide quality online content to the community. This is accomplished by providing a virtual credit or token means by which members can exercise a “vote” for content that is useful to them and/or to the online community as a whole. A Member who creates or contributes content can receive such a “vote” from other members who give the contributing member one or more virtual credits or tokens for the contributed content. Members who have received virtual credits or tokens benefit directly and proportionately by sharing in the revenue generated by the online community. This results in monetary gains for both the online community operator and the contributing members in a synergistic way. As the quality of the content and number of members increase, greater revenue can be realized which gives an incentive to members to produce additional positive content which will further increase the revenue of the online community. As for the viewing members, they benefit from higher quality and more relevant content since the “voting” method will encourage more contributions that are of higher quality and more satisfactory to the viewers of the content.

Members who are professionals or have subject matter expertise can further benefit by being recognized as an expert in their field by making positive contributions related to their field. They can display on their profile page the number of positive votes acquired (in the form of redeemable tokens described further below) for their contributions and also links to their website to further increase their business. Members may to choose to designate themselves as an expert in one or more areas (e.g. medicine, law, movies, etc). If a discussion thread is started in a particular subject matter area, a member who has designated themselves as an expert in such subject matter may be automatically notified. An expert member participating in a community discussion forum may choose to designate whether his contribution to the discussion thread is being made as an expert or as a regular member. The ability to designate whether the contribution is being made as an expert or a regular member will allow more flexibility in the way the member can participate in or start a discussion thread. A contributing member may mark whether a contribution to a discussion is being made as an expert or lay member. This allows viewers of a discussion thread to easily see whether the response is being made as an expert or a lay member.

It is contemplated that the online community members will be comprised of individuals who are registered users of a website operated on a computer system that is accessible over a network such as the internet. The website is provided and run by a website operator which may, for example, be an individual, company, organization, group of persons, etc. . . . It is contemplated that the website and data for the display of web pages and content will be stored on one or more computer servers that members and others may access remotely over a network, such as the internet. It is contemplated that the website will also generate revenues, such as through advertising.

The voting system contemplated is one where the registered members would vote by transferring one or more virtual non-redeemable tokens (hereinafter a “NRT”) in their accounts to the accounts of content providing contributing members based upon how useful the voting members found the content to be. When a member votes and a NRT in a voting member's account is transferred to a contributing member's account it would, once in the possession of the receiving contributing member, be changed into a virtual redeemable token (hereinafter a “RT”). The RTs a member acquires are used by the website operator periodically to have the computing system calculate a share of the website revenues that would be deposited into a contributing member's account.

A member can request a payout of the money deposited into their member account. A member requesting a payout may be responsible for the fees or costs incurred by the website operator for transferring the money (e.g. PayPal fees) to the member. Should this be the case then it may have the effect of members letting the money accumulate in the member's account. The money in a member's account can be used to purchase items in one or more online stores associated with the community.

### BRIEF DESCRIPTION OF THE DRAWINGS

FIG. 1 is a flow chart diagram illustrating the general operation of a preferred embodiment of the online membership incentive system using tokens.

FIG. 2 is a flow chart diagram illustrating a preferred embodiment of the distribution and use of NRTs in the incentive system of the present invention.

FIG. 3 is a flow chart diagram illustrating a preferred embodiment of how the computer system determines and distributes shared community revenues to a contributing member account.

### BEST MODE FOR CARRYING OUT THE INVENTION

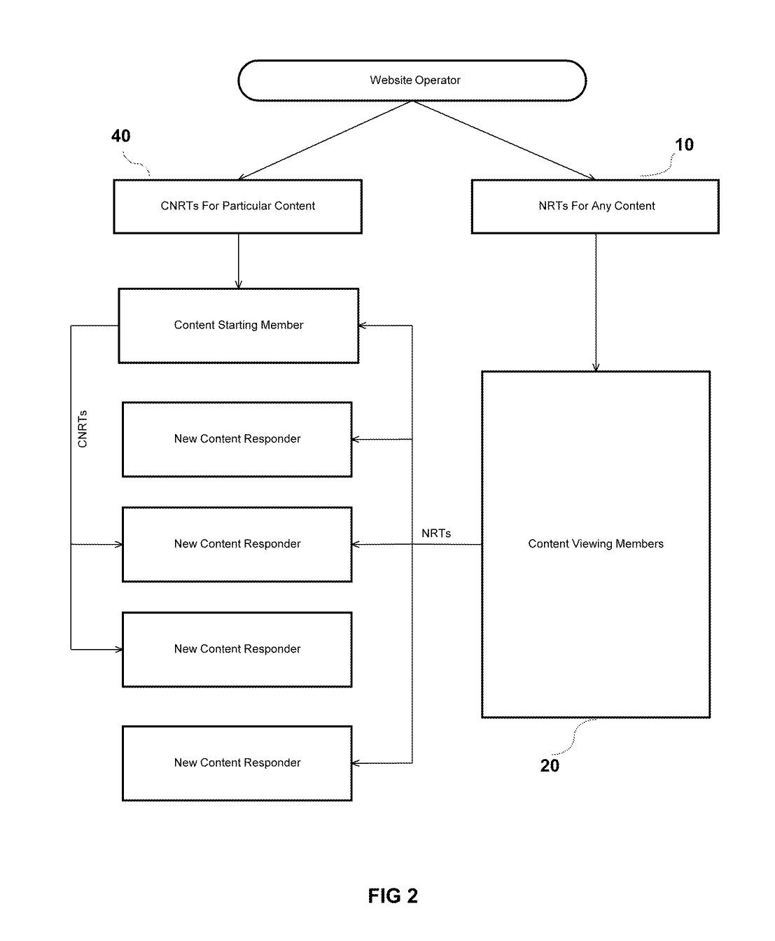

Referring to FIG. 2, in the present invention all registered users of a community would receive from the computer system a certain number of virtual NRTs. In a preferred embodiment of the invention described herein, where the online community is a website, such NRTs would be represented graphically or descriptively on the website to registered users as “silver tokens”, while RTs would be represented graphically or descriptively on the website to registered users as “gold tokens”. It should be noted that only two classes of tokens are described in connection with the preferred embodiment but other classes of tokens can be implemented depending on the online setting. The website may contain a content list or index that can be displayed in various ways to show the silver tokens (NRTs) and gold tokens (RTs) received for different content on the website. This serves to allow a member to quickly find content to respond to, or find the most popular content.

In a preferred embodiment silver tokens (NRTs) are intended to be given away and have limited or no value by themselves. Silver tokens (NRTs) not given away after a certain time period, and/or after a certain number of times a registered user has logged in to the website, will expire automatically. For example, silver tokens (NRTs) still remaining in a registered user's account will expire after 10 logins or after ten days, whichever comes first, from the time of issuance of the silver tokens (NRTs).

Silver tokens (NRTs) are given away by members to other members who make a positive contribution to the online community and/or to the giving member. Positive contribution here usually means starting a discussion thread, blog, or other content, and also members who respond to such content in a meaningful way. In particular registered users would use the silver tokens (NRTs) they receive to vote on the content provided by other registered users of the website.

As shown in FIG. 2 all registered users of the website will receive all purpose silver tokens (NRTs) 10 according to a member token distribution formula that is determined by the website operator. The member token distribution formula may take into consideration things such as, for example, a registered user's frequency of logging in, average time spent on website, age of membership on website, number of threads or blogs subscribed to by user, number of redeemable tokens, etc. . . .

For example, one silver token (NRT) may be assigned to a registered user each time that the user logs in to the website, with a maximum of three silver tokens (NRTs) per twenty-four hour period. Another example may be that a user receives one silver token (NRT) each time the user acquires a gold token (RT). Yet another example may be that one silver token (NRT) is received for every 20 minutes of time spent on the website with activities (viewing pages, participating in threads etc. . . . ).

Another example may be one silver token (NRT) is received for every five responses made to content (thread, blog, etc. . . . ) on the website. These are just some examples of silver token (NRT) distribution formulas that may be used by a website operator, and are not limitations on the many variations there may be.

As shown in FIG. 2 members are free to browse through the website and give away their all purpose silver tokens (NRTs) 20 to other members who have made a positive contribution (as determined by the token giving member) to the online community or to the token giving member. When a member browses content, for example a thread on the website, the member can give an all purpose silver token (NRT) 20 (or multitude of silver tokens (NRTs), the limit of which will be determined by the rules of the website) to the thread starter or to any of the responders to the thread. It does not matter how many gold tokens (RTs) the thread starter or the responders have already received from other members.

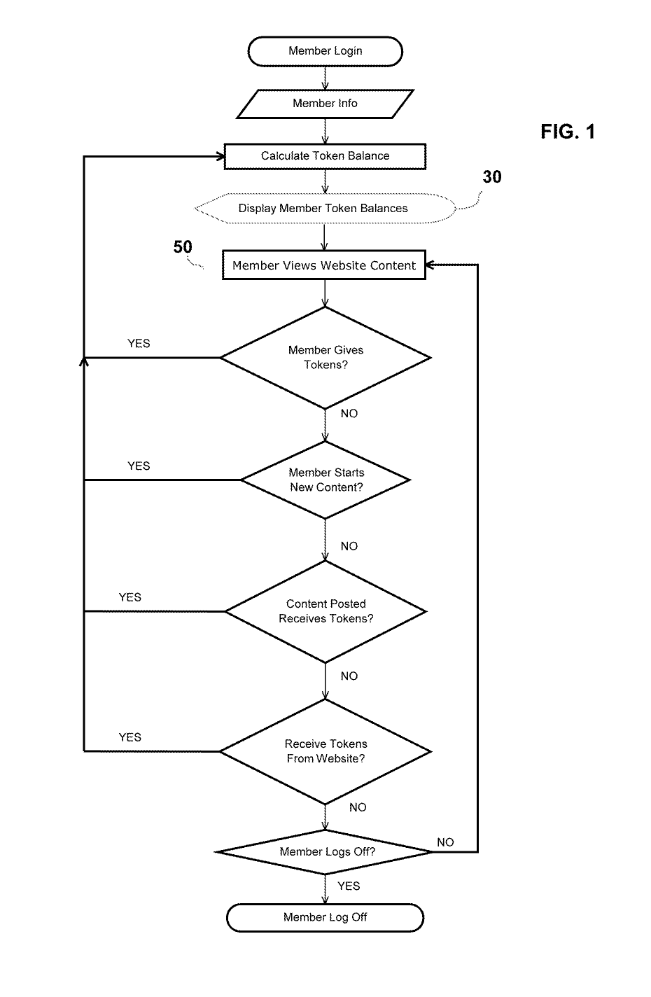

As shown at 30 in FIG. 1. it is contemplated that a part of the screen that is visible to a member when on the website will display the number of silver tokens (NRTs) remaining for them to give away and also the amount of gold tokens (RTs) that they have acquired. The member can also click on a statistics area and see a history of to whom they gave their silver tokens (NRTs) and for which content. Similarly, a history of when their silver tokens (NRTs) were assigned and their expiration date (number of logins left before they expire) can be accessed. History can also be accessed for their gold tokens (RTs) which will show how the gold tokens (RTs) were received (from what other members, for what particular content, or from the website operator for other work done, etc. . . . ).

Referring to FIG. 2 it is also contemplated in a preferred embodiment that registered users who provide content will receive additional content restricted silver tokens (CNRTs) 40 according to a content restricted token distribution formula. The content restricted token distribution formula determines a number of content restricted silver tokens (CNRTs) to be given to a registered user who has started particular content (e.g. started a thread or blog). The content restricted token distribution formula may take into consideration such things as the type of content (discussion thread, blog, etc. . . . ) and nature of the content (seeking advice, etc. . . . ). It should be noted that the invention contemplates that the only limitation on content would be that imposed by the website operator, and the present invention is intended to apply to all types of content. By way of example and not limitation content may be textual (short stories, jokes, experiences, etc. . . . ), audio (songs, instrumentation, readings, how to's, etc. . . . ), video, graphics, visual arts, images, animation, etc. . . . When a member starts new content, the member will enter information, perhaps by way of checking a category box, on the type of content for the purpose of calculating the content restricted token distribution formula and assigning the correct number of content restricted silver tokens (CNRTs).

By way of example, and not limitation, the content restricted token distribution formula may provide for ten content restricted silver tokens (CNRTs) to be assigned to a thread or thread starter if the thread belongs to the category of asking questions or seeking advice, while only five content restricted silver tokens (CNRTs) are assigned to the thread or thread starter if the thread does not belong to the category of asking questions or seeking advice. This is just an example of a content restricted token distribution formula that may be adopted by a website operator, and is not a limitation on the many variations there may be.

It is further contemplated that content restricted silver tokens (CNRTs) are assigned to the content starting member for use only in connection with the new content (thread, blog, etc. . . . ). Content restricted silver tokens (CNRTs) are intended to be given away by the content starting member for responses to the new content deemed positive. Other registered users who view the content will be able to see the number of content restricted silver tokens (CNRTs) remaining to be given away for responses to the particular content. This encourages responses to the content in a timely manner.

For example, referring to FIG. 1. at 50, when a registered user looks at the titles of the threads on the website, the registered user will also be able to see information for each thread which will show the amount of content restricted silver tokens (CNRTs) originally assigned to the thread and the amount of content restricted silver tokens (CNRTs) remaining that can be given out by the thread starter. If the thread starter asked for and received additional content restricted silver tokens (CNRTs) (due to popularity and response to the thread), it will also be indicated as such here (how many additional content restricted silver tokens (CNRTs) received and how many remaining) Additionally, a registered user will be able to see the total number of gold tokens (RTs) acquired by responders to the thread which is a good indicator of the popularity of the thread as a whole. This information can be represented numerically or graphically.

In the preferred embodiment any silver token (NRT or CNRT), is converted to a gold token (RT) the moment it is given from one member to another for actions that are positive contributions to the online community as a whole or to the giving member. In a preferred embodiment the ratio 1:1 is used for the conversion, with one gold token (RT) being assigned to the recipient of each silver token (NRT or CNRT) from other members. However, this is just an example, and the website operator may use any conversion ratio without departing from the invention.

The number of gold tokens (RTs) acquired by a member indicates the level of positive contributions that other members think the member has made to the website and to its members. Information on the gold tokens (RTs) received can be displayed on a member's profile page, either as private or public information selectively by the member. Other members who have given silver tokens (NRTs or CNRTs) to the member are displayed on the profile page as members who “like” the member's contributions and form a group of associated members, in addition to other possible groups (e.g. friends, etc. . . . ).

It is contemplated that the computer system of the present invention would track members who give silvers tokens (NRTs or CNRTs), what time the silver tokens (NRTs or CNRTs) were given, and which content or responses the given silver tokens (NRTs or CNRTs) related to. The computer system of the present invention would also show the amount of gold tokens (RTs) received in the member's avatar or profile page. The computer system of the present invention would also alert a member when a gold token (RT) was acquired by posting a message on the member's profile page, via email, PM, mobile text, etc. . . . The computer system of the present invention could also alert a member when other members acquire gold tokens (RT) for threads or blogs that they are subscribed to by a message on the profile page, via email, PM, mobile text, etc. . . . The computer system of the present invention will also facilitate easy communication between the giver and receiver of the tokens, for thanks, further questions or comments, or to become friends.

It is also contemplated that certain website members can be promoted to special members or mediators for the purpose of various tasks that are not easily automated. One of them being the ability to assign additional content restricted silver tokens to content starters on threads where having additional content restricted silver tokens (CNRTs) would be beneficial and fitting to the way the thread is progressing. Other examples of such activities may include providing services to the website, efforts to promote the website, referring new members to the site, and acting as a moderator of content or discussion groups. So for example, members that engage in verifiable promotional activities for the website can be special members. These members would go to the mediators who will verify the activity and hand out the gold tokens (RTs) for the special contributions. Likewise, members who refer their friends to the website can obtain gold tokens (RTs). This can include referrals generated by sending out invites by automatically accessing the members email list.

The website operator may give gold tokens (RTs) to special members or mediators for their special contributions. Gold tokens (RTs) given to members for their special contributions may have a different appearance or description from other tokens.

In a preferred embodiment of the present invention the website generates revenues, and these are divided by the website operator into one or more revenue categories (hereinafter “RCAT”). While there may be just one RCAT, it is contemplated that a website operator will divide website revenues into multiple revenue categories (RCATs). For example, a first revenue category (RCAT₁) may be advertisement revenue directly tied to particular content created by a member (e.g., a specific thread in which the member acquired one or more gold tokens (RTs), either as a thread starter or responder). A second revenue category (RCAT₂) may be advertisement revenue indirectly tied to the particular content created by the member (e.g., main page of the discussion forum section or the main pages of the content sub categories). A third revenue category (RCAT₃) may be advertisement revenue not tied to the particular content created by the member, except in the broadest sense (e.g., main page of the website). A fourth revenue category (RCAT₄) may be non-advertisement revenue (e.g., selling of data).

TABLE 1
Example Website Revenue Categories

| | |
|---|---|
| RCAT₁ | Ad Revenues Directly Tied To A Member's Content |
| RCAT₂ | Ad Revenues Indirectly Tied To A Member's Content |
| RCAT₃ | General Website Ad Revenues Independent of Content |
| RCAT₄ | Non-Ad Revenues (e.g. selling data) |

The RCATs specified herein are just by way of example. There is no limit to the number of RCATs, and a website may have more or less RCATs, and of different types, without departing from the invention.

The website operator permits members to share in the revenues of a particular RCAT by allowing members to acquire gold tokens (RTs) in connection with that RCAT. The computer system periodically distributes a share of the revenues from a given RCAT to individual members in proportion to the number of gold tokens (RTs) that an individual member has of the total number of gold tokens outstanding for that RCAT. The proportion of the individual member's gold tokens (RTs) to the total number of gold tokens (RTs) outstanding for a RCAT is called the redeemable token quotient (hereinafter the “RTQ”).

So for example, if there is a first revenue category RCAT₁, and the total number of outstanding gold tokens that all members have acquired in connection with RCAT₁ at the end of the month is twenty, then an individual member who holds two of the twenty gold tokens (RTs) would have a RTQ of 10%. It is contemplated that this individual member would receive a share of the revenues from RCAT₁ in proportion to his 10% RTQ. It should be noted that the RTQ need not be limited to a direct percentage of outstanding gold tokens (RTs) for a particular RCAT. Other formulas may be developed by the website operator for determining the RTQ of members.

The specific revenue sharing formula for any particular RCAT can take into account many factors chosen by the website operator, but always takes into account the number of gold tokens (RTs) acquired by a member. In particular it is contemplated that members who have gold tokens (RTs) associated with a particular RCAT will receive a share of the revenues from that RCAT in proportion to their RTQ for the RCAT. The exact proportion, time frame, and manner in which the revenue is shared will be determined by the website operator. The key point is that the RTQ is a required component of the revenue sharing formula used to calculate a member's share of website revenues from any given RCAT.

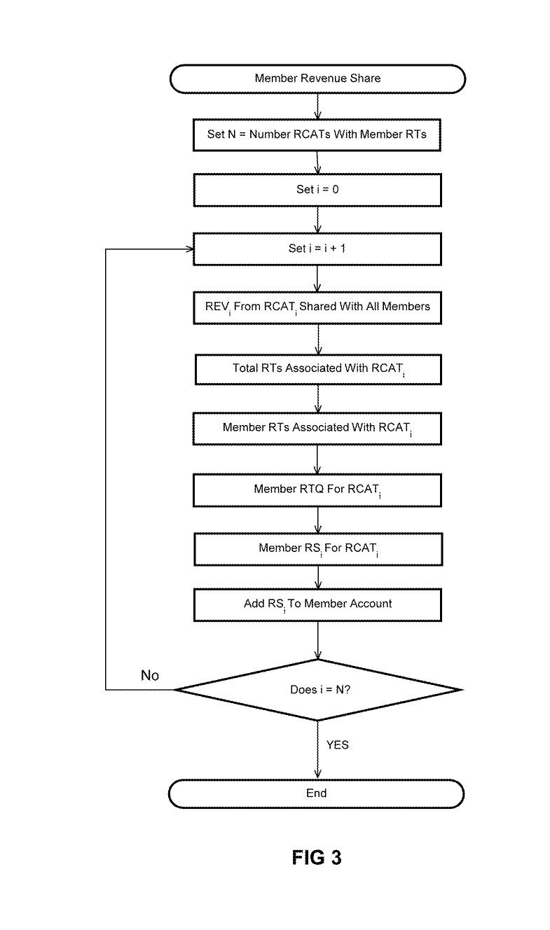

Referring to FIG. 3, in a website that has a number N of multiple revenue categories (RCATs) it is contemplated that for each RCAT an individual member's revenue share would be determined at a given time in proportion to their current RTQ for that RCAT, and that the sum of all revenue shares from the individual revenue categories (RCATs) would equal a total revenue share (TRS) for the individual member at that time.

This can be represented by the following total member revenue share formula, where N is the total number of revenue categories, and REV_{RCAT} is the amount of revenue from a particular RCAT that the website operator will sharing with all members who have gold tokens (RTs) associated with the particular RCAT.

### Total Member Revenue Share Formula

$$TRS = {\sum }_{i = 1}^{N} {RTQ}_{{RCAT}_{i}} \times {REV}_{{RCAT}_{i}}$$

$${RTQ}_{{RCAT}_{i}} ∝ \frac{{( RTs of Member for RCAT )}_{i}}{{( Total RTs for RCAT )}_{i}}$$

$${REV}_{{RCAT}_{i}} = Revenues From {RCAT}_{i} Shared With Members$$

A hypothetical example showing an application of the above member revenue share formula is illustrated below in the TABLE 2 where there are three (N=3) revenue categories (RCATs) from which members are sharing the revenues. In this example members with gold tokens (RTs) would be entitled to collectively receive a share of the website revenues equal to 25% of RCAT₁, plus 15% of RCAT₂ revenues, plus 5% of RCAT₃ revenues. The percentage of revenue from each RCAT to be shared amongst the members is to be determined by the website operator. By applying the member revenue share formula to the exemplary information set forth in the table, which would be calculated by the system of the present invention, the total revenue share (TRS) of each individual member eligible to share in revenues from a RCAT may be determined.

TABLE 2
Total Member Revenue Share Example

| | | Amount | | | | |
|---|---|---|---|---|---|---|
| | | Shared | Total Gold | Gold | | |
| | Total | With | Tokens | Tokens | | |
| | RCAT | Members | (RTs) For | (RTs) of | | Member |
| | Revenue | (REV) | RCAT | Member | RTQ | Share |
| RCAT₁ | $200 | $50 | 20 | 2 | 10% | $5 |
| RCAT₂ | $100 | $15 | 14 | 7 | 50% | $7.50 |
| RCAT₃ | $100 | $5 | 10 | 3 | 30% | $1.50 |

TRS=[RTQ_{RCAT1}×REV_{RCAT1}]+[RTQ_{RCAT2}×REV_{RCAT2}]+[RTQ_{RCAT3}×REV_{RCAT3}]

TRS=[10%×$50]+[50%×$15]+[30%×$5]

TRS=[$5]+[$7.50]+[$1.50]

TRS=$14.00

So in the above illustrative example the individual member would have a total revenue share (TRS) of $14.00. This would be deposited into the contributing member's account.

In a preferred embodiment the revenue sharing method is also based on the number of page views of the content where a member has gold tokens (RTs). In this method, total revenue that is to be shared with the membership is divided among eligible content based on a relative popularity factor (“RPF”) which factors in the number of page views for content. In such an embodiment, for example, the amount of money REV_{RCATy} for sharing with members having gold tokens (RTs) associated with a content Y would be determined using a RPF that is proportional to the number of page views there were for content Y relative to total page views for all eligible revenue sharing content on the site.

### Relative Popularity Factor (RPF)

$${REV}_{{RCAT}_{y}} = {RPF}_{y} \times Total Revenue To Share$$

$${RPF}_{y} ∝ \frac{Page Views Content Y}{Total Eligible Content Page Views}$$

For example, if the total number of page views for all site content eligible for revenue sharing with members was 1000, and content Y received 100 page views out of the total 1000 page views, then the RPF may be 10%. The 10% RPF would be applied to the total revenue to be shared by all members to determine the amount of revenue REV_{RCATy} to be shared amongst those members having gold tokens (RTs) associated with content Y. So, if the RPF was 10% (100/1000), and if the total revenue to be shared with all site members was $500, then the total revenue REV_{RCATy} to be allocated for sharing amongst members having gold tokens (RTs) associated with content Y may be calculated as $50 (10%×$500). That REV_{RCATy} of $50 would then be distributed to the members having gold tokens (RTs) associated with content Y in proportion to each member's RTQ_{RCATy} for content Y. So, continuing the example, if there were a total of 100 gold tokens (RTs) associated with content Y, and a particular member had 50 of those gold tokens (RTs), that member would have a RTQ_{RCATy} of 50% (50/100). That member would then receive a share of $25 for content Y:

RS=RTQ_{RCATy}×REV_{RCATy}

RS=50%×$50=$25

The above embodiment is merely exemplary, with there being many ways of allocating revenue shares among site content using a relative popularity factor (RPF). One way is to do a straight page view proportion method. Another method can allocate revenues only for content which has the top percentiles of page views, dropping lower ranking content with very few page views. The RPF may also be determined using factors other than, or in addition to, the number of page views for content. An example may be using the average amount of time spent by users on particular content relative to the site average as a factor for calculating a RPF.

It is contemplated that one form of revenue for the website or community will be from advertising. More specifically that such revenues may be from users viewing or clicking on advertisements. To preserve the integrity of revenue sharing system it is contemplated that the computer system will implement a method to prevent revenue sharing fraud by members, or a Fraud Prevention Component (hereinafter the “FPC”).

The FPC prohibits particular members from viewing and/or clicking on revenue generating features, such as ads, when such members would be entitled to a share of the revenue from such ads. In an exemplary embodiment the FPC would operate by utilizing one or more mechanisms to identify the particular user requesting access to a web page from the system server. Such a mechanism may be for example a user id, session id, cookie, IP address, or other user identifying means.

Once the user is identified the FPC of the computer system would then determine whether or not there is a revenue share alert for the member with respect to the requested section of the community. One criteria for a revenue share alert is if the requesting member gas has gold tokens (RTs) associated with that section of the community. If it was determined that the requesting member did have gold tokens (RTs) associated with requested section then a revenue share alter would be established by the computer system and the requested section would be served to the requesting member without any revenue generating features, such as ads where the member would be entitled to a share of the revenues from a click or display of the ad.

Instead no ads, or Non-Revenue Sharing Ads (hereinafter “NRSA”) that the requesting member is not entitled to a share of revenues in, would be displayed on the served section. NRSAs may be for the same advertiser as a revenue generating ad, but may be altered by the computer system such that they do not count towards number of ad impressions or are non-clickable (e.g. have the hypertext link removed or disabled on the page). A NRSA may be identified as such by visual means to a section visitor (e.g. a member having gold tokens (RTs) associated with section content).

It is also contemplated that the FPC may also make a determination as to whether or not a member requesting a page had any known association with another user who has gold tokens (RTs) associated with the content on the requested page. Such an association may be, for example, being registered on the system as a “friend” or “connection” of a user having gold tokens (RTs) associated with the content. If the FPC determined that the requesting user had a known association with a user having gold tokens (RTs) associated with the content on the requested page then a revenue share alert would be established and the page served would display no ads, or only display NRSAs.

It is further contemplated that the computer system would also have means to discourage click-fraud on the system such as using click monitoring software and a penalty system where the accounts of any users found to be engaging in any kind of click fraud would lose all of their gold tokens (RTs) and/or have their accounts terminated.

It is contemplated that in practice a website operator would use the computer system to calculate and distribute revenues to members once a month at the end of the month. However, this can be done more or less frequently without departing from the invention. A member can request a payout of the money deposited into their member account. The payout can be in any form, but a contemplated method is through PayPal®. A member requesting a payout may be responsible for the fees or costs incurred by the website operator for transferring the money (e.g. PayPal® fees). Should this be the case then it may have the effect of members being motivated to let the money accumulate in the revenue share account.

The money in a member's account can be used to purchase items in one or more online stores associated with the website. In particular it is contemplated that members of the website may provide original creative content (music, paintings, etc) and will be able to set up a store fronts associated with the website to sell their content. In this way members may benefit from being provided with an easy and direct means of capitalizing on the popularity of their work, by sharing in the revenue of the online community. Means can also be provided through which sales of their work directly to the members and to the public can be easily facilitated.

Means can also be provided whereby members can choose to donate part or all of the revenue sharing earned from the website to a charity of their choice or choose among the charities listed by the website operator. Means are provided whereby members who choose to donate their proceeds to charity are given a seal or medal or other conspicuous display means which can be displayed on their profile page or next to or near their member name so that they can be recognized by other viewers or members.

1. An incentive method to share revenues with contributing members of an online community operated on a computer system accessible over a computer network comprising the steps of said computer system:
providing at least one transferable non-redeemable token to an account of at least one member of said online community;
converting each non-redeemable token transferred from a member account to another contributing member account into a redeemable token associated with a revenue category;
assigning a portion of online community revenue to said revenue category;
calculating a contributing member revenue category share amount using a redeemable token quotient for each contributing member having redeemable tokens associated with said revenue category; and
depositing into said each contributing member's account said revenue category share amount.

2. The method of claim 1 further comprising the step of providing at least one content restricted non-redeemable token to an initiating contributing member account for particular content, wherein said content restricted non-redeemable token may only be transferred by said initiating contributing member to a non-initiating member account for an additional contribution by said non-initiating member to said particular content.

3. The method of claim 1 further comprising the step of tracking information on how non-redeemable tokens are used by a member.

4. The method claim 1 further comprising the step of displaying to a member the amount of said non-redeemable tokens and amount of said redeemable tokens associated with said account of said member.

5. The method of claim 1 further comprising representing said non-redeemable tokens as silver tokens, and said redeemable tokens as gold tokens.

6. The method of claim 1 further comprising said online community being a website.

7. The method of claim 1 further comprising said redeemable token quotient being equal to the number of redeemable tokens a contributing member has for said revenue category divided by the total number of redeemable tokens for said revenue category.

8. The method of claim 1 further comprising sending a message to a member when there is a change in the number of redeemable tokens in said member's account.

9. The method of claim 1 further comprising said portion of online community revenue to be assigned to said revenue category being determined using a relative popularity factor.

10. The method of claim 9 further comprising said relative popularity factor being proportional to the number of views in a time period of a particular online community content divided by the total number of views of online community content in said time period.

11. A method to prevent revenue sharing fraud by members of an online community operated on a computing system accessible over a computer network comprising the steps of said computer system:
identifying a requesting member prior to granting access to a requested section of said online community;
determining if there is a revenue share alert for said requesting member with respect to said requested section; and
displaying said requested section to said requesting member without any revenue generating features if there is a revenue share alert.

12. The method of claim 11 further comprising said revenue share alert being established if said requesting member has a redeemable token for any revenue category associated with said requested section.

13. The method of claim 11 further comprising said revenue share alert being established if said requesting member has an existing online community relationship with any other member having a redeemable token for a revenue category associated with said requested section.
